(19) United States
(12) Patent Application Publication
(10) Pub. No.: US 2008/0167940 A1
(43) Pub. Date: Jul. 10, 2008

(54) METHOD AND STRUCTURE FOR INCREASING REVENUE FOR ON-DEMAND ENVIRONMENTS

(76) Inventors: Parijat Dube, Yorktown Heights, NY (US); Laura Wynter, Chappaqua, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/620,333

(22) Filed: Jan. 5, 2007

(51) Int. Cl. G06Q 10/00

(52) U.S. Cl. 705/10; 705/400

(57) ABSTRACT

A method and structure for computing a capacity-dependent price for an on-demand scenario includes a demand model module that stores a demand model for the on-demand scenario. A supply model module stores an evaluation of at least one of available and total supply for the on-demand scenario. A computing module relates the demand and supply for the on-demand scenario and computes a capacity-dependent price.

### BACKGROUND OF THE INVENTION

1. Field of the Invention

The present invention generally relates to a method and software-implemented tool to optimize revenue in on-demand environments, such as on-demand contact centers (ODCC) with slots as resources, or applications-on-demand, including software as a service.

2. Description of the Related Art

In one exemplary embodiment used for explanation of concepts, the problem being addressed by the present invention deals with increasing revenue in on-demand contact centers (ODCC) with slots as resources. The concept, however, is more generic and relates more generally to the on-demand paradigm. The on-demand paradigm is one in which resources can be obtained with very little delay, and in most cases, through the Internet.

Thus, returning again to the ODCC embodiment, typically, a slot corresponds to the functionality to support one agent. FIG. 1 exemplarily shows a traditional enterprise model 100 for a contact center or call center 101 having two agents 102, 103 available to receive calls from customers or clients 104, using a communication system 105, such as a telephone system, a computer internet system, etc.

Call centers, which typically are considered as service centers, are now being looked upon as profit-making units. Moreover, recently, many companies have started providing on-demand contact center hosting services. A hosting service is an internet-based service in which a service provider supplies computer infrastructure (hardware, software, and networks) and allows other companies to use the service provider's hardware (in the case of a capacity hosting service) such as memory or CPU, software (in the case of hosted applications, or software-as a-service, and/or network, in the case of hosted websites. In all these examples, a service provider “hosts” customers on its own IT infrastructure, be it hardware, software, network, or any combination of those resources.

Some popular companies providing ODCC hosting services are: Siebel OnDemand Contact Center (www.crmondemand.com), Echopass On-demand Solutions (www.echopass.com), Five9 Virtual Contact Center (www.five9.com), Contactual OnDemand Contact Center—formerly White Pajama (www.contactual.com), and Eagle ACD (www.eagleacd.com).

FIG. 2 shows the concept of expanding the traditional enterprise model of contact centers 100 (shown in FIG. 1) into an enterprise model 200 in which a company 206 purchases a program to set up a contact center 201 having agent slots 202, 203 to service its customers 204 via communication system 205. In this version of the traditional enterprise model of Contact Centers, the customer 206 (e.g., the company that wishes to establish a contact center 201) needs to purchase the whole contact center solution outright, deploy the solution in-house and support it. FIG. 2, therefore, shows two types of “customers” 204, 206, wherein customer 206 is the company that purchases the contact center 201 as a package to service its own customers 204.

The ODCC concept 300, as shown in FIG. 3, replaces the traditional enterprise models 100, 200 by offering customers (e.g., 206 in FIG. 2) the flexibility to gain software functionality and IT (information technology) support resources 301 for setting up contact centers 301A, 301B, 301C on a subscription basis. It is noted that each contact center 301A, 301B, 301C has respective agents 302, 303 servicing customers 304 via communication system 305. It is also noted that, clearly, the number of contact centers 301A, 301B, 301C, the number of agents 302, 303, the number of customers 304, and the number of communication systems 305 are intended as non-limiting examples for purpose of explanation of the present invention.

Typical pricing structure at an ODCC includes a long term flat subscription fee for entering into contract with the ODCC (and using its solution) and a variable fee for the usage of slots (as and when needed) during the period of contract. The variable fee can be charged on a monthly basis and depends on the number of slots currently in use by the customer. The per slots price during the duration of contract is fixed at the time of contract signing. Thus, there is no dynamic price setting of the slots during the duration of contract.

Moreover, there are no known revenue optimization techniques that are followed by ODCCs. The revenue obtained by this price structure does not depend on the demand level and fails to exploit customer heterogeneity in terms of their priority level for service, the price they are willing to pay, etc.

Thus, the present inventors have recognized that a need exists in ODCCs to optimize revenues for companies hosting contact centers.

Moreover, the technique of the present invention can be used in other on-demand environments, such as applications on-demand.

### SUMMARY OF THE INVENTION

In view of the foregoing, and other, exemplary problems, drawbacks, and disadvantages of the conventional systems, it is an exemplary feature of the present invention to provide a method (and structure) in which revenues can be maximized for companies hosting contact centers, by using dynamic pricing of slots, according to the market profile, the demand level etc.

It is another exemplary feature of the present invention to expand the revenue maximization technique to any on-demand environment.

In a first exemplary aspect of the present invention, described herein is an apparatus, including a demand model module storing a demand model for an on-demand scenario, a supply model module storing an evaluation of at least one of available and total supply for the on-demand scenario, a price module storing at least one price for the on-demand scenario, and a computing module that relates the demand and supply for the on-demand scenario and computes a capacity-dependent price.

In a second exemplary aspect of the present invention, also described herein is a method of managing an on-demand scenario, including developing a demand model, developing a supply model, relating the demand and supply models, and computing a capacity-dependent price for the on-demand scenario.

For the contact center embodiment, advantages of the present invention include increased revenue through dynamic pricing, exploitation of contact center customer segmentation so as to maximize revenue, and exploitation of periods of increased demand level so as to maximize revenue. The present invention will allow greater profit to be derived from on-demand environments through judicious pricing and also permits smoothing of the demand, i.e., targeted pricing with the intention of shifting demand to desired (e.g. under-utilized) periods, in a profitable manner.

Corresponding advantages are provided when the technique is applied in other on-demand scenarios.

### BRIEF DESCRIPTION OF THE DRAWINGS

The foregoing and other purposes, aspects and advantages will be better understood from the following detailed description of an exemplary embodiment of the invention with reference to the drawings, in which:

FIG. 1 exemplarily shows interactions 100 for a two-agent ODCC 101;

FIG. 2 exemplarily shows the interactions 200 for a two-agent ODCC 201, as modified to incorporate the hosting service concept;

FIG. 3 exemplarily shows the interactions 300 for concept of subscriptions capability of hosting services;

FIG. 4 illustrates exemplarily a flowchart 400 for implementing the techniques of the present invention;

FIG. 5 illustrates an exemplary embodiment 500 of the present invention in the context of the hosting services environment;

FIG. 6 illustrates an exemplary block diagram 600 of a software tool that implements the present invention;

FIG. 7 illustrates an exemplary hardware/information handling system 700 for incorporating the present invention therein; and

FIG. 8 illustrates a signal bearing medium 800, 802 (e.g., storage medium) for storing steps of a program of a method according to the present invention.

### DETAILED DESCRIPTION OF AN EXEMPLARY EMBODIMENT OF THE INVENTION

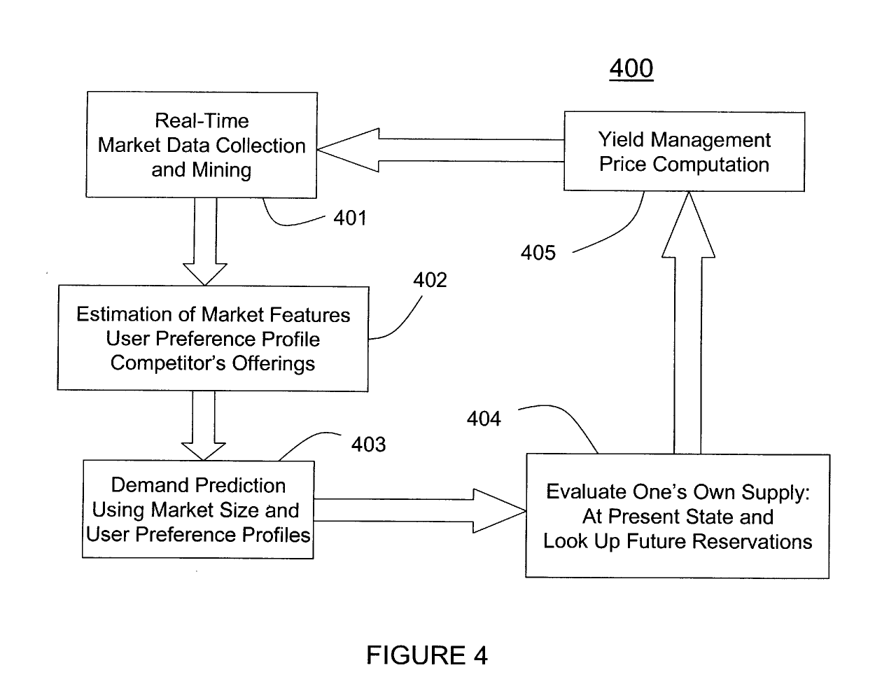

Referring now to the drawings, and more particularly to FIGS. 4-8, an exemplary embodiment of the present invention will now be described.

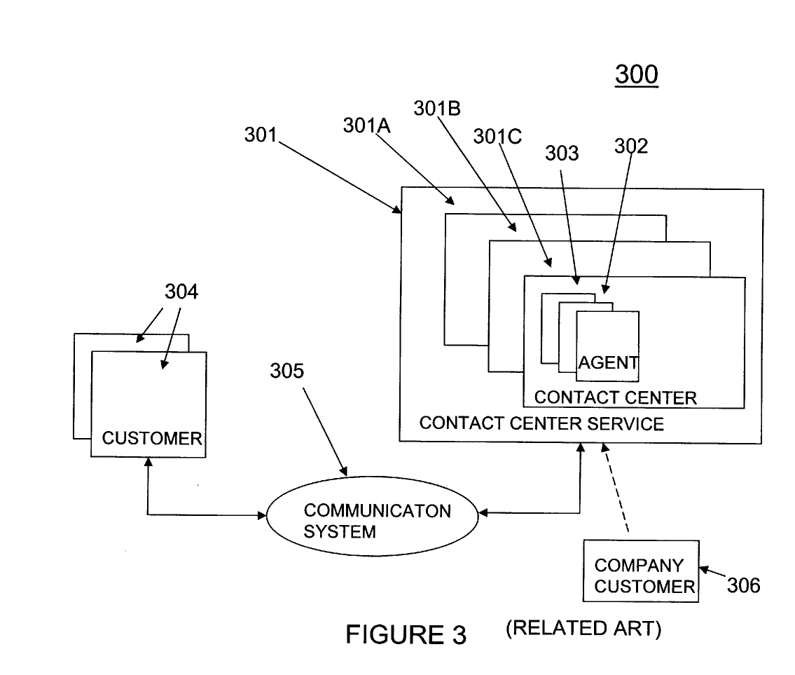

The on-demand paradigm, exemplarily illustrated in FIG. 3 for the on-demand contact center, allows for lower set-up costs in a variety of businesses. The methods proposed herein take advantage of natural customer segmentation to increase revenues, and to enable targeted pricing strategies to be implemented profitably. Similar techniques have been applied to the airline industry and other hospitality industries, such as car rentals, golf courses, and restaurants. The present inventors previously developed a means for performing these techniques, sometimes referred to as revenue management, for IT on-demand, for computational resources. The resources covered were primarily system level resources: CPU shares, memory, bandwidth, etc.

The present invention presents a pair of higher-level applications of this technology: 1) for on-demand workplace hosting, and 2) for on-demand applications, which include Software as a Service®. Both of these applications are explained below.

Major components of such a system include demand-segmentation and capacity-dependent pricing, along with a means for offering the electronic service by way of the Internet.

### On-Demand Workplace Hosting

On-demand hosting solutions allow for very low uptimes (e.g., several hours) and remote agents. Depending on demand, customers can “add-on” additional virtual “slots” during the period of contract, as needed.

As previously mentioned, many companies exist today to provide contact/call centers on-demand. Although on-demand contact centers ODCC are used to explain the concepts of the present invention, there are other on-demand scenarios, such as e-commerce solutions on-demand, offered by tachyonsolutions.com. It is expected that other businesses will follow, for example, on-demand trading desk, online helpdesk (e.g., IBM's acquisition iPhrase®), etc.

### Applications On-Demand

Therefore, there are a number of on-demand scenarios, referred to as applications on-demand, and a broad variety of application areas fall into this category. As examples, there are Software as a Service (e.g., opsource.net, appstream.com), Digital Cable TV on-demand (comcast.com, hbo.com), games on-demand, including online gaming (e.g., Atari® on-demand), video on-demand, including online video and pay-per-view (e.g., tv.net, maven.net, akimbo.com, vod.com), online help on-demand (netopUSA.com), and E-commerce (e.g., demandware.com). It is expected that increases in demand with respect to capacity will induce a need for revenue increasing techniques, such as used in the present invention.

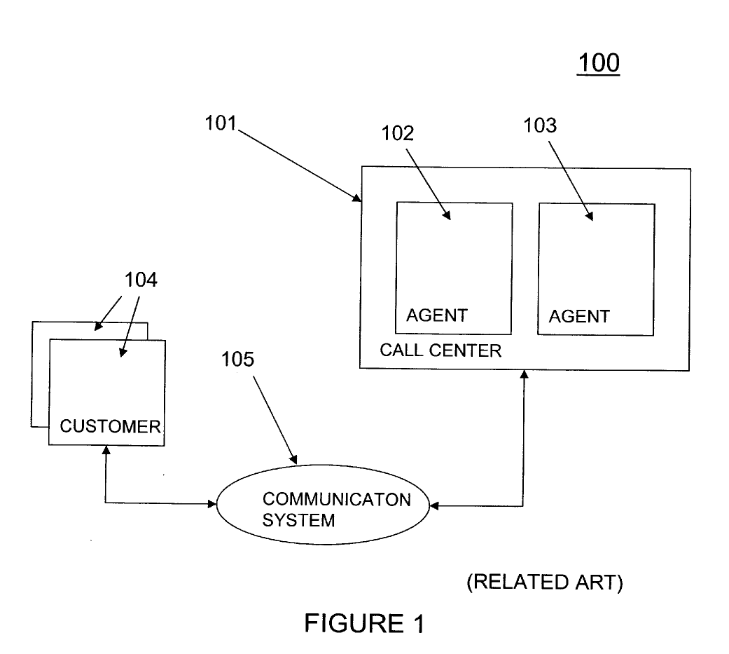

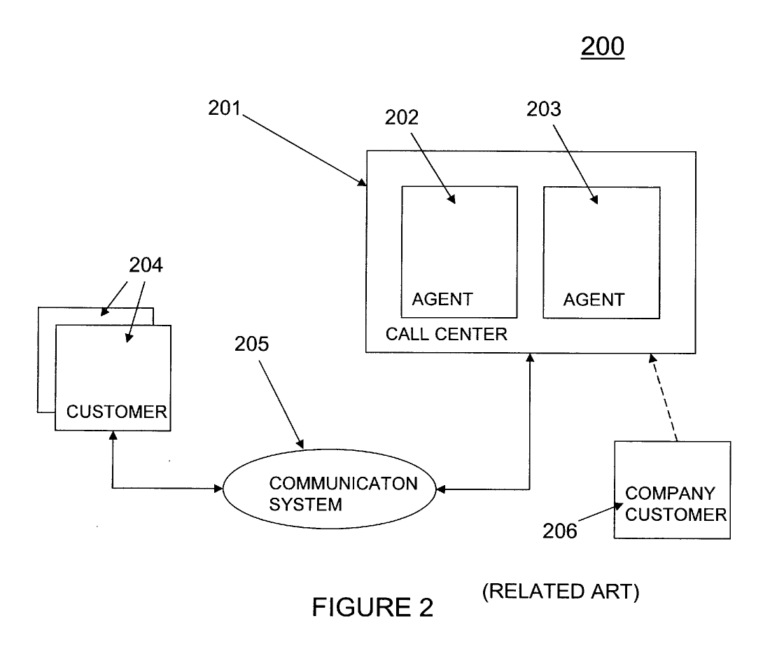

The techniques of the present invention apply to any on-demand scenarios such as those described above, including the on-demand contact centers ODCCs illustrated in FIGS. 1-3.

These techniques which make use of dynamic pricing of contact center slots will increase profit and can be coupled with other sales promotion techniques (complimentary slots with the purchase of some number of slots, discounted price, etc.) to improve overall customer satisfaction.

The technique of an exemplary embodiment of the present invention can be summarized by describing that, using demand models and customer choice models, the revenue maximization is then solved as a (possibly) non-linear optimization problem. The solution provides the number of slots and the price level at which they should be offered in subsequent periods. Customers can choose between different numbers of slots at different times depending on the utility they intend to derive by outsourcing their demand to this company.

FIG. 4 shows exemplarily how the technique 400 of the present invention can be implemented. Using a demand model 401, an evaluation of available supply in total 402, and at least one price 403, a computation mechanism 404 relates the demand and supply and computes the capacity-dependent price(s). The computation mechanism 404 as described below is a mathematical equation implemented and optimized by software within a computer.

The ODCC hosting company forecasts the demand for subsequent periods. This can be based on historical data about the level of demand during different times of the year, the level of demand associated with certain events, announcements, and also the segmentation of demand based on customer choice functions, etc.

Once a demand model is generated, the best number of slots to be offered and the price at which they will be offered in different subsequent periods can be obtained by using optimization techniques with the goal being to maximize the expected revenue over a planning horizon (e.g., a group of consecutive periods over which the revenue needs to be maximized, like 2 years, 5 years, etc.). There can be a plurality of customer choice functions, a plurality of demand forecasting and demand models and a plurality of ways in which the optimization problem can be formulated.

An exemplary formulation of the optimization problem (for the on-demand contact center implementation) for a planning horizon of T periods is now discussed, beginning with definitions for notation:
T_{icq}: duration (in unit of offering period, i.e., monthly weekly, etc.) for which additional slots of type q will be needed by the customer of type c at time i
r_{ikq}: price of a slot of type q at time i in class k
n_{ikq}: number of slots of type q offered in class k at time i by the ODCC
n: vector of slots offered by the ODCC, for each type, time period, and class
r: vector of prices of different slots offered by the ODCC
P(T_{icq}, n, r): probability that a customer of type c will accept a slot of type q at time i (customer choice function)
Γ_{c}: probability that a customer is of type c
   Then the model over the planning horizon can be formulated as

$${max}_{{r}_{ikq} , {n}_{ikq}} {\sum }_{c = 1 … C} {\sum }_{i = 1 … T} {\sum }_{k = 1 … K} {\sum }_{q = 1 … Q} {T}_{icq} {r}_{ikq} {n}_{ikq} P ( {T}_{icq} , n , r ) {Γ}_{c}$$

The solution to this optimization problem will give the number of slots of different types that can be offered in different time periods and the price at which they are offered so as to maximize the overall revenue over the planning horizon. A constraint is that the offered number of slots should not exceed the physical capacity of the ODCC in any period.

Also, since the amount of time a slots is needed by a customer depends on his demand and is different for different customers, it can be modeled as a random variable (the distribution function can be obtained using historical data) and then the objective function can be taken to be the “expected” revenue. There can be other constraints, too, such as reserving some number of slots for some priority customers (with which the ODCC has long-term relationship, etc.).

This mathematical model can be solved by any program that accepts nonlinear optimization problems, such as MATLAB, or any of numerous specialized optimization solvers.

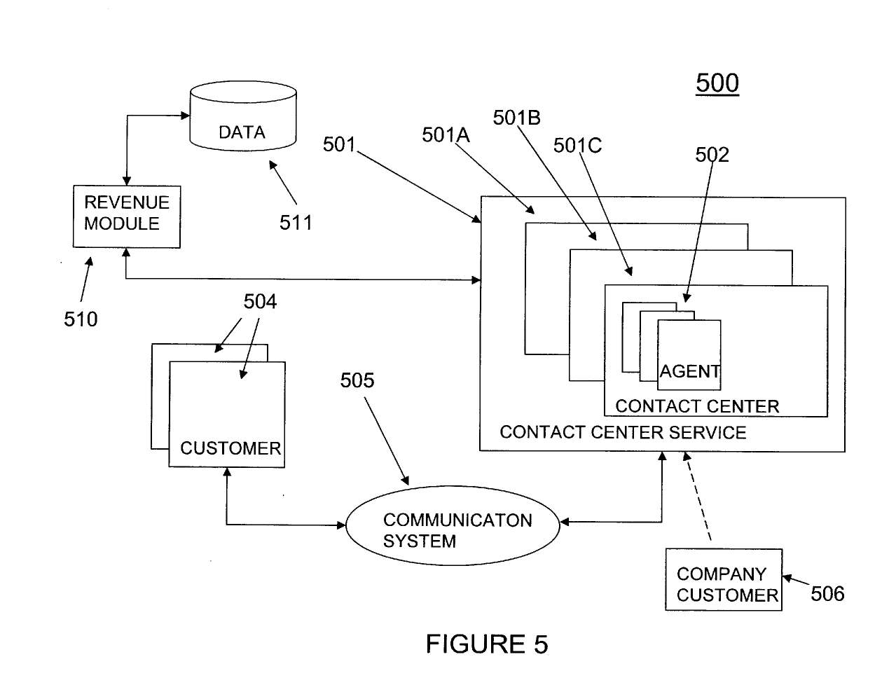

FIG. 5 illustrates how the present invention might fit into the context of a hosting services environment similar to that previously illustrated in FIG. 3. The user of the present invention provides software functionality and IT support resources 501 for setting up contact centers 501A, 501B, 501C on a subscription basis to clients 506. Each contact center 501A, 501B, 501C has respective agents 502 who will service customers 504 via communication system 505. The software module 510 that embodies the method of the present invention would be located in a computer, either at the location 501 providing the support resources or remotely. Data storage 511 provides the repository for data gathered through operation of the various contact centers 501A, 501B, 501C, thereby providing the historical data for the model.

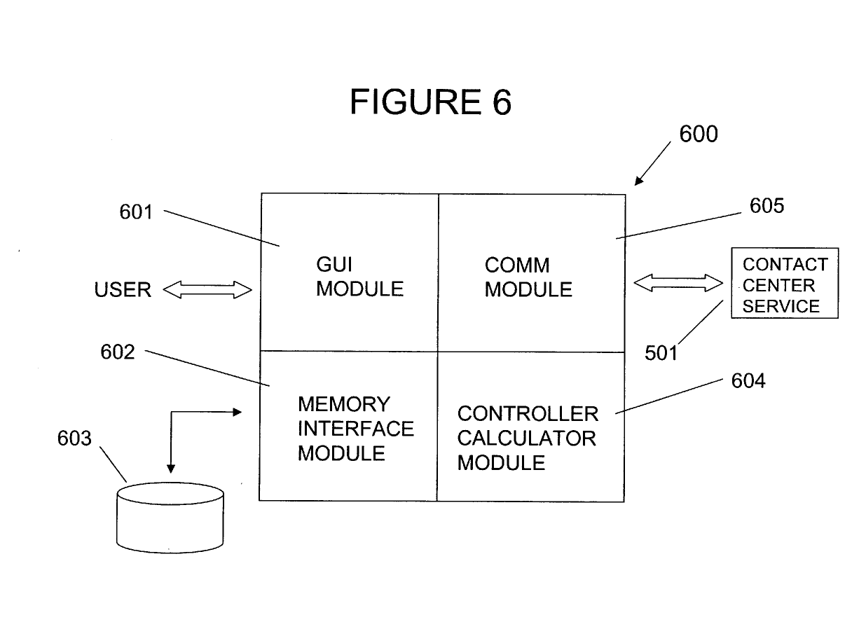

FIG. 6 shows an exemplary block diagram 600 of modules 601, 602, 604, 604, 605 exemplarily used to implement the present invention. The GUI module 601 allows the user (e.g., the provider of the subscription service for contact centers) to interface with the various modules of the software, including the display of the results of the optimization, etc. Memory interface module 602 controls data exchange with database 603 and controller/calculator module 604 provides overall control and performs the optimization calculations described above. Database 603 could have any number of data inputs, including current marketing information related to the demand and supply models. Communication module 605 receives data from the contact centers 501 to be forwarded to storage 603.

Another module (not shown in FIG. 6) could be added for automating some of the possible business interfaces with clients, including automated contracting of services ordered dynamically by clients as they accept various offerings output from the controller/calculator module 604 and possibly payments for services rendered.

### Exemplary Hardware Implementation

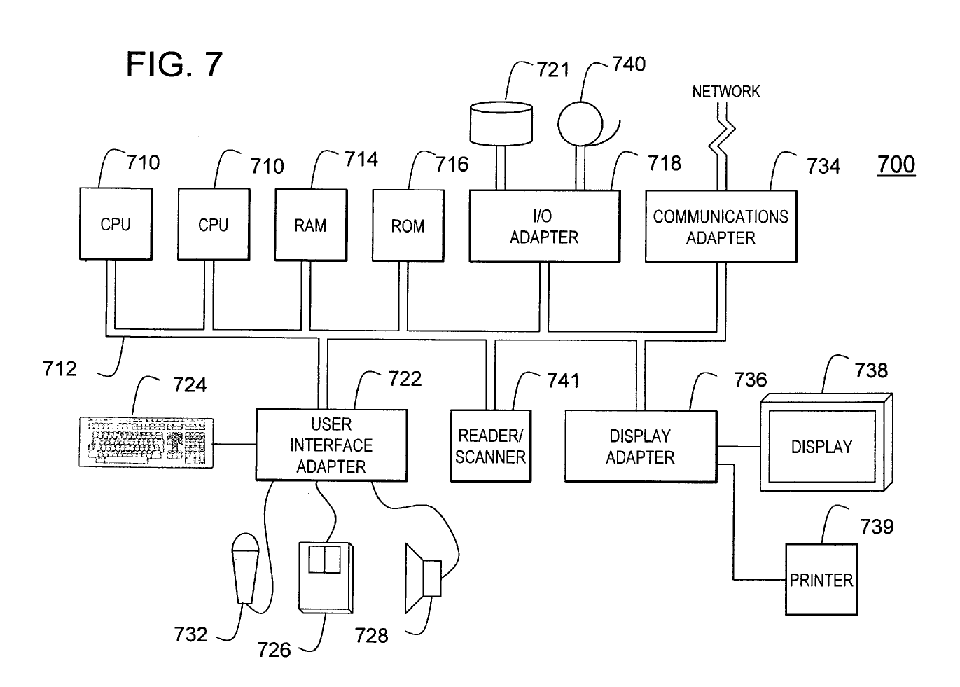

FIG. 7 illustrates a typical hardware configuration of an information handling/computer system in accordance with the invention and which preferably has at least one processor or central processing unit (CPU) 710.

The CPUs 710 are interconnected via a system bus 712 to a random access memory (RAM) 714, read-only memory (ROM) 716, input/output (1/0) adapter 718 (for connecting peripheral devices such as disk units 721 and tape drives 740 to the bus 712), user interface adapter 722 (for connecting a keyboard 724, mouse 726, speaker 728, microphone 732, and/or other user interface device to the bus 712), a communication adapter 734 for connecting an information handling system to a data processing network, the Internet, an Intranet, a personal area network (PAN), etc., and a display adapter 736 for connecting the bus 712 to a display device 738 and/or printer 739 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 710 and hardware above, to perform the method of the invention.

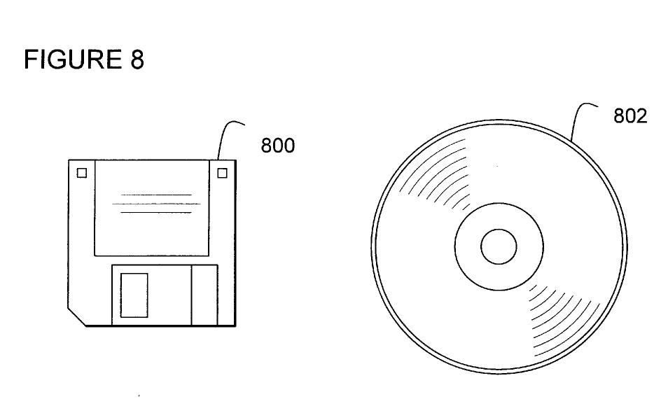

This signal-bearing media may include, for example, a RAM contained within the CPU 710, as represented by the fast-access storage for example. Alternatively, the instructions may be contained in another signal-bearing media, such as a magnetic data storage diskette 800,802 (FIG. 8), directly or indirectly accessible by the CPU 710.

Whether contained in the diskette 800,802, the computer/CPU 710, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

In yet another aspect of the present invention, it should be apparent from the above discussion that the technique of the present invention also lends itself to a business method of providing a service for on-demand scenarios, wherein one entity provides the present invention as a service to other entities operating an on-demand scenario.

It is readily apparent from the discussion above that the present will allow greater profit to be derived from on-demand environments through judicious pricing, and will permit smoothing of the demand, i.e., targeted pricing with the intention of shifting demand to desired (e.g. under-utilized) periods, in a profitable manner.

While the invention has been described in terms of an exemplary embodiment, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. An apparatus for managing an on-demand scenario, comprising:
a module for developing a demand model;
a module developing a supply model;
a module for relating said demand and supply models; and
a module for computing a capacity-dependent price for said on-demand scenario.

2. The apparatus of claim 1, wherein said on-demand scenario comprises any of:
an on-demand contact center;
an on-demand call center;
an on-demand workplace hosting service;
an application on-demand service; and
an application including software as a service or call center management or contact center management or information technology hosting.

3. The apparatus of claim 1, wherein said capacity-dependent price is computed at each of various points in time.

4. The apparatus of claim 1, wherein said capacity-dependent price is computed over a selective period of time comprising a planning horizon.

5. The apparatus of claim 1, wherein said demand model and said supply model are based on at least one of historical data and current data.

6. The apparatus of claim 1, further comprising a module wherein said capacity-dependent price is used for at least one of:
increasing revenue for said on-demand scenario; and
managing a reservation for said on-demand scenario.

7. The apparatus of claim 1, wherein said module computing said capacity-dependent price includes an optimization solver.

8. The apparatus of claim 5, wherein at least one of said demand model and said supply model is derived at least partially by data mining of market data.

9. The apparatus of claim 7, wherein, for an on-demand scenario, said optimization solver solves a problem generally defined as a number of slots of different types that can be offered in different time periods and a price at which said slots can be offered so as to increase revenue over a planning horizon.

10. The apparatus of claim 9, wherein said on-demand scenario comprises an on-demand contact center (OODC) and a model over the planning horizon is formulated as:
$${max}_{{r}_{ikq} , {n}_{ikq}} {\sum }_{c = 1 … C} {\sum }_{i = 1 … T} {\sum }_{k = 1 … K} {\sum }_{q = 1 … Q} {T}_{icq} {r}_{ikq} {n}_{ikq} P ( {T}_{icq} , n , r ) {Γ}_{c}$$
T_{icq}: duration (in unit of an offering period) for which additional slots of type q will be needed by a customer of type c at time i
r_{ikq}: price of a slot of type q at time k in class k
n_{ikq}: number of slots of type q offered in class k at time i by the ODCC
n: vector of slots offered by ODCC, for each type, time period, and class
r: vector of prices of different slots offered by ODCC
P(T_{icq}, n, r) : probability that a customer of type c will take a slots of type q at time i (customer choice function)
Γ_{c}: probability that a customer is of type c.

11. A signal-bearing medium tangibly embodying a program of machine-readable instructions executable by a digital processing apparatus and which instructions comprise the modules described in claim 1.

12. A method of managing an on-demand scenario, said method comprising:
developing a demand model;
developing a supply model;
relating said demand and supply models; and
computing a capacity-dependent price for said on-demand scenario.

13. The method of claim 12, wherein said capacity-dependent price is computed over a selective period of time comprising a planning horizon.

14. The method of claim 12, wherein said demand model and said supply model are based on at least one of historical data and current data.

15. The method of claim 12, further comprising at least one of:
increasing revenue for said on-demand scenario; and
managing a reservation for said on-demand scenario.

16. The method of claim 12, wherein said capacity-dependent price is computed by an optimization solver.

17. The method of claim 14, wherein at least one of said demand model and said supply model is derived at least partially by data mining of market data.

18. The method of claim 16, wherein, for an on-demand scenario, said optimization problem solves a number of slots of different types that can be offered in different time periods and a price at which said slots are offered so as to maximize an overall revenue over a planning horizon.

19. A method of providing a business service, said method comprising one or more steps of the method of claim 12 as a service to a business executing an on-demand service.

20. A signal-bearing medium tangibly embodying a program of machine-readable instructions executable by a digital processing apparatus to execute the method of claim 12.
